(19) United States
(12) Patent Application Publication
(10) Pub. No.: US 2006/0077897 A1
(43) Pub. Date: Apr. 13, 2006

(54) Method and apparatus for download prioritization

(75) Inventor: Michael D. Kotzin, Buffalo Grove, IL (US)

Correspondence Address: LAW OFFICES OF CHARLES W. BETHARDS, LLP, P.O. BOX 1622, COLLEYVILLE, TX, 76034, US

(73) Assignee: MOTOROLA, INC.

(21) Appl. No.: 10/963,146

(22) Filed: Oct. 12, 2004

(51) Int. Cl. H04J 1/16; H04J 3/14

(52) U.S. Cl. 370/235

(57) ABSTRACT

A method (700) and apparatus (601) control information transfer in a Radio Access Network (RAN) between a network content server (101) and a network client (420), e.g. wireless subscriber device, over an Internet network (102) by determining a likelihood of a request for a unit of information including a hypertext link to a page (315) associated with an Internet website. Information is transferred using a push transfer operation based on the likelihood. A request frequency for the unit of information from a second network client (430) affects the likelihood. A request profile for the network client includes a request history and the likelihood is based on the request profile. The push transfer is made automatically without the request from the network client.

### CROSS REFREENCE TO RELATED APPLICATIONS

The present invention is related to U.S. Patent Application Publication 2003 0163444 A1, entitled “METHOD TO OPTIMIZE INFORMATION DOWNLOADING” filed Feb. 27, 2002 and assigned to the same assignee as the present invention.

### FIELD OF THE INVENTION

The present invention relates in general to Radio Access Networks (RANs), and more specifically to a method and apparatus for prioritization and automatic transfer of information to network clients.

### BACKGROUND OF THE INVENTION

With the widespread proliferation of RANs, cellular networks, network servers, portable electronic devices, laptops, wireless communication units, cellular handsets, and the like, having the ability to connect to a RAN through a wireless connection, the ability to rapidly transfer information to such devices has become an important factor in maximizing usability and enjoyment for a user of the device. This is particularly true and may be problematic with the transfer of large amounts of information typically associated with World Wide Web pages available on the Internet and the like and when the RAN environment serves a large number of wireless users on constrained channels.

When the RAN environment includes many portable electronic devices, each making requests for information, an individual device often must wait for large amounts of information associated with web pages or requested from other users to be transferred or at least must wait for the information it requested to be loaded due to other network traffic, which can consume the available wireless capacity. Such waits are particularly acute when connected to a relatively crowded network environment. Thus the rapid, convenient, efficient, and enjoyable use of portable electronic devices can be compromised when browsing content on a network such as a wireless network or when browsing a network by way of a wireless network interface. Such limitations are especially acute when rapid access to information is desired. A mobility client for example, looking for immediate directions to a location using an on-line mapping service or the like, may not be in a position to wait for web page information to download. Other similar situations arise when rapid access to content is desirable.

### BRIEF DESCRIPTION OF THE DRAWINGS

The accompanying figures, where like reference numerals refer to identical or functionally similar elements and which together with the detailed description below are incorporated in and form part of the specification, serve to further illustrate a preferred embodiment and to explain various principles and advantages in accordance with the present invention.

FIG. 1 is a diagram illustrating an exemplary network, network server, and network clients including wireless network clients associated with a network environment;

FIG. 2 is a diagram illustrating simplified and representative exemplary network clients requesting information from a server in accordance with various exemplary embodiments;

FIG. 3 is a diagram illustrating exemplary network content provided by an exemplary server in accordance with various exemplary embodiments;

FIG. 4 is a diagram illustrating exemplary request frequency tracking of requests for network content by network clients in accordance with various exemplary embodiments;

FIG. 5 is a diagram further illustrating the exemplary request frequency tracking of requests shown in FIG. 4, with broadcast transfer in accordance with various exemplary embodiments;

FIG. 6 is a block diagram illustrating components of an exemplary apparatus in accordance with various exemplary and alternative exemplary embodiments; and

FIG. 7 is a flow chart illustrating an exemplary procedure in accordance with various exemplary embodiments.

### DETAILED DESCRIPTION

In overview, the present disclosure concerns Radio Access Networks, network content servers and network clients including wireless clients and portable electronic devices such as communications devices or units, often referred to as communication units or wireless communication units, such as cellular telephone or two-way radio handsets and the like having the ability to access a network such as the Internet to request and receive network content such as pages on the world wide web. Such pages are often accessed through links such as Hypertext links containing an address, or Universal Resource Locator (URL) in the form of “http://www.websitename.ext” wherein “http” stands for Hypertext Transfer Protocol, “www” stands for world wide web, “websitename”+“ext” or extension, refers to the domain name for the location of the desired content plus an extension typically referring to type of domain such as “edu” for educational domains, “com” for commercial domains, “org” for organizational domains and the like as is described in greater detail, for example in documents published by organizations such as the World Wide Web Consortium (W3C), and the Internet Engineering Task Force (IETF) well known to those of ordinary skill in the art.

More particularly, various inventive concepts and principles are embodied in network servers and other infrastructure components within the RAN such as base station transceivers connected to networks accessed by network clients such as communication devices, and methods therein for prioritizing information transfers based on request frequency determined for the information being transferred. It should be noted that, with reference to network clients, in addition to connoting a typical wireless client, the term portable electronic device or communication unit may be used interchangeably with subscriber unit, wireless subscriber unit, wireless subscriber device or the like connoting wireless clients having access to the RAN through various wireless access protocols. Each of the terms used to connote a portable electronic device or wireless communication unit represents a device ordinarily associated with a user and typically a wireless mobile device that may be used with a public network or within a private network such as an enterprise network. Examples of such units include personal digital assistants, personal assignment pads, and personal computers equipped for wireless operation, a cellular handset or device, or equivalents thereof. The term server as used herein connotes a computer having a network interface and the capacity to service requests for information from clients which information may be contained on the server or on a storage device or other device accessible by the server.

The instant disclosure is provided to further explain in an enabling fashion the best modes of performing one or more embodiments of the present invention. The disclosure is further offered to enhance an understanding and appreciation for the inventive principles and advantages thereof, rather than to limit in any manner the invention. The invention is defined solely by the appended claims including any amendments made during the pendency of this application and all equivalents of those claims as issued.

It is further understood that the use of relational terms such as first and second, and the like, if any, are used solely to distinguish one from another entity, item, or action without necessarily requiring or implying any actual such relationship or order between such entities, items or actions.

Much of the inventive functionality and many of the inventive principles when implemented, are best supported with or in software or integrated circuits (ICs), such as general purpose processors, dedicated processors, application specific ICs (ASICs), digital signal processors, or the like and software therefore. It is expected that one of ordinary skill, notwithstanding possibly significant effort and many design choices motivated by, for example, available time, current technology, and economic considerations, when guided by the concepts and principles disclosed herein will be readily capable of generating such software instructions or ICs with minimal experimentation. Therefore, in the interest of brevity and minimization of any risk of obscuring the principles and concepts according to the present invention, further discussion of such software and ICs, if any, will be limited to the essentials with respect to the principles and concepts used by the preferred embodiments.

In addition to devices of a general nature connected to networks using wireless connections, the communication devices, clients, and servers of particular interest are those providing or facilitating wireless voice/audio communications services over cellular wide area networks (WANs), such as conventional two way systems and devices, various cellular phone systems including analog and digital cellular, CDMA (code division multiple access) and variants thereof, GSM (Global System for Mobile Communication), GPRS (General Packet Radio System), 2.5G and 3G systems such as UMTS (Universal Mobile Telecommunication Service) systems, Internet Protocol (IP) Wireless Wide Area Networks like 802.16, 802.20 or Flarion, integrated digital enhanced networks and variants or evolutions thereof. Furthermore the wireless communication units or devices of interest may have short range wireless communications capability normally referred to as WLAN capabilities, such as IEEE 802.11, Bluetooth, or Hiper-Lan and the like preferably using CDMA, frequency hopping, OFDM (orthogonal frequency division multiplexing) or TDMA (Time Division Multiple Access) access technologies and one or more of various networking protocols, such as TCP/IP (Transmission Control Protocol/Internet Protocol), UDP/UP (Universal Datagram Protocol/Universal Protocol), IPX/SPX (Inter-Packet Exchange/Sequential Packet Exchange), Net BIOS (Network Basic Input Output System) or other protocol structures. Alternatively the wireless communication units or devices of interest may be connected to a LAN (Local Area Network) using protocols such as TCP/IP, UDP/UP, IPX/SPX, or Net BIOS via a hardwired interface such as a cable and/or a connector.

As further discussed herein below, various inventive principles and combinations thereof are advantageously employed to provide prioritization of information for transfer including autonomous transfer, such as push transfer, to network clients.

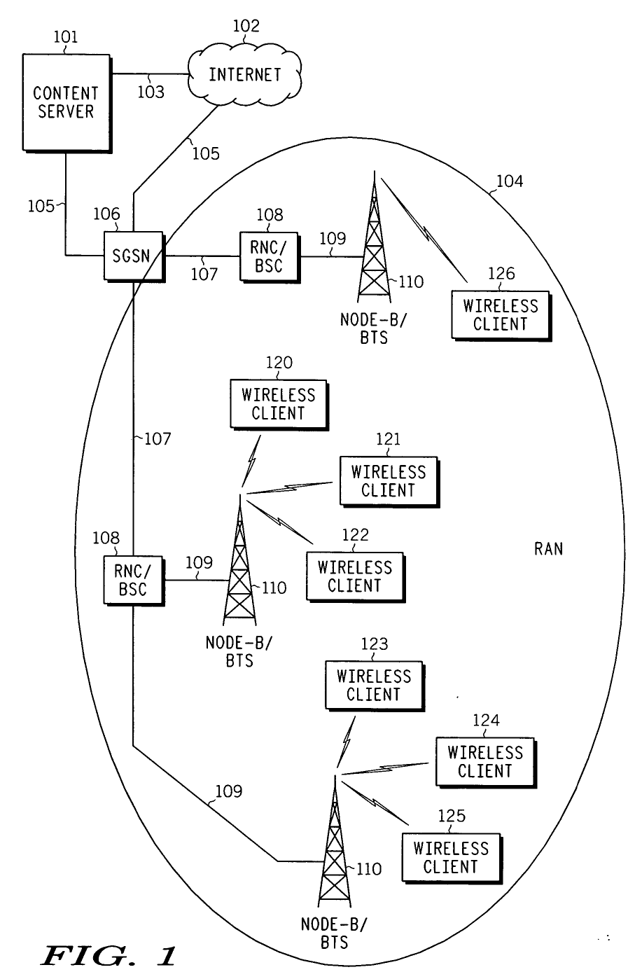

As the network environment becomes more diverse and heterogeneous, driven in large measure by the expansion of wireless and related mobility oriented network access, the typical Radio Access Network (RAN) network configuration now includes the ability to service a diverse client base with Internet connectivity and the like. As can be seen in FIG. 1, an exemplary computer system or content server 101 can be connected to a network such as Internet 102 through a network connection and a network interface 103, which in turn may be coupled to wireless network clients 120-126 in a Radio Access Network (RAN) 104 which can be a General Packet Radio Service (GPRS) network or the like as described above. It will be appreciated that the wireless network clients 120-126 are typically connected to the RAN 104 and ultimately to the Internet 102 and the content server 101 through a series of connections 105, 107, and 109 to devices within the RAN 104 such as a Base Transceiver Station (Node B/BTS) 110, a Radio Network Controller/Base Station Controller (RNC/BSC) 108, and a Serving GPRS Support Node (SGSN) 106. Alternative configurations can include coupling the wireless clients 120-126 and the content server 101 through the Node B/BTS 110, the connection 109, the RNC/BSC 108, the connection 107, and the SGSN 106. It should be noted that from the SGSN 106, the connection 105 can be made to the Internet 102 and then to the content server 101 over connection 103, or the SGSN 106 can connect directly to the content server 101. For illustrative purposes, SGSN 106 is shown in subsequent figures as being connected to the content server 101 through connection 105, however other connection configurations are possible as noted.

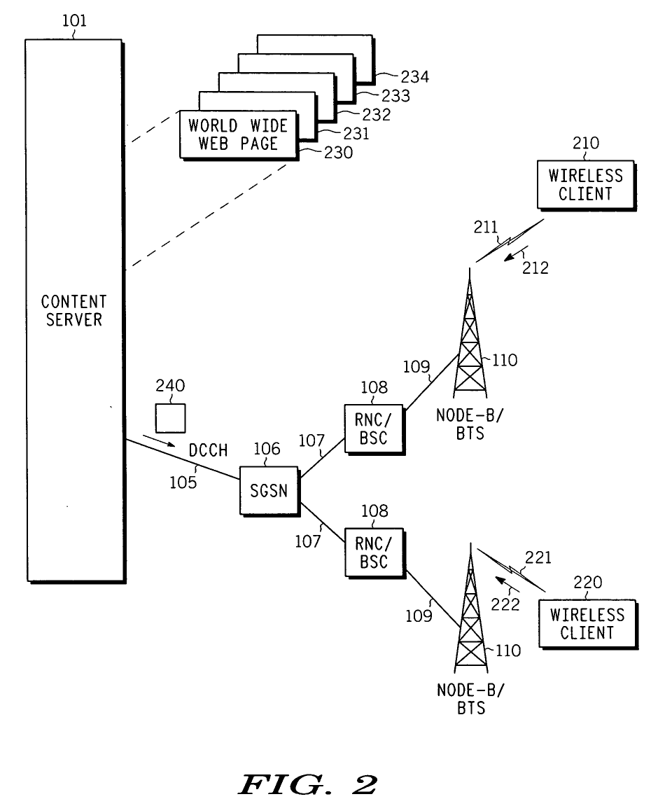

Thus in accordance with various exemplary embodiments as depicted, for example in FIG. 2, server 101 can store or otherwise access content such as information pages 230-234 which can be World Wide Web pages or the like. The content server 101 can provide the content to the wireless network clients 210 and 220 either upon request or automatically in accordance with various exemplary embodiments, without receiving a specific request as will be described. It should be noted that in the related application noted herein above, U.S. Patent Application Publication 2003 0163444 A1, a method is described for managing a Priority Download List (PDL) within a device such as a wireless client based on pages accessed via Hyperlinks or the like. As the device navigates pages, the PDL is updated and pages indicated by priority on the PDL are requested and downloaded from an infrastructure in the background even though not specifically requested by a user. It is briefly noted in U.S. Patent Application Publication 2003 0163444 A1, that management of the PDL or PDL-like metrics, request frequencies or the like, may also be conducted within the network infrastructure. The present invention has additional advantages in that request frequencies of many clients can be tracked and associative relationships established such that for members of certain client groups or associative groupings of clients, forward page references can be predicted based on the most frequent browsing activities and page requests of members of the groups or groupings. The tracking can be updated and relationships pruned as more information is developed within the infrastructure related to preferences as will be described.

Accordingly, the activities of the wireless network clients 210 and 220 can be tracked within the infrastructure such as within the content server 101 or within the SGSN 106, or the like, or a combination of infrastructure components. For simplicity, the present invention will be discussed with reference to hit tracking and the like conducted within the content server 101 or within a like device. However it will be understood to those of skill in the art that tracking and other activities in accordance with various exemplary embodiments can be conducted within various infrastructure components or within a combination of infrastructure components.

The wireless network clients 210 and 220 and other wireless network clients can issue, for example, requests 212 and 222 for content from the content server 101, such as a request for one of the pages 230-234, in a manner known in the art, such as by accessing a Hypertext link associated with existing content. The Hypertext link can be included within content displayed on, for example, user interfaces associated with the wireless network clients 210, and 220 and a Universal Resource Locator (URL) or the like can be sent to the Internet 102 associated with the link, whereupon the content server 101 will be addressed and the content 240 associated with the link can be transferred to the requesting client.

It will be appreciated that by using the term “accessing” in discussing a Hypertext link, reference is made to, for example pointing to the link with a cursor controlled by a pointing device such as a mouse, trackball, or the like, and selecting or “clicking” on the link whereupon information associated with the link such as the domain address and page identifier is passed to the network interface by an application such as a browser or the like as will be appreciated by one of ordinary skill. It will be appreciated that while the inventive concepts discussed and described herein are directed primarily to wireless networks, they can be applied to wired networks and clients connected thereto over, for example, a modem interface, an Ethernet interface, or the like. The content server 101 may process requests for content from the wireless network clients 210 and 220, by transferring the content 240 which can be a web page or the like as described above. As noted above, when the number of network clients grows large, the amount of information transferred becomes large and if many requests for large amounts of information are received simultaneously, wait times for information can increase leading to degradation in the user's experience.

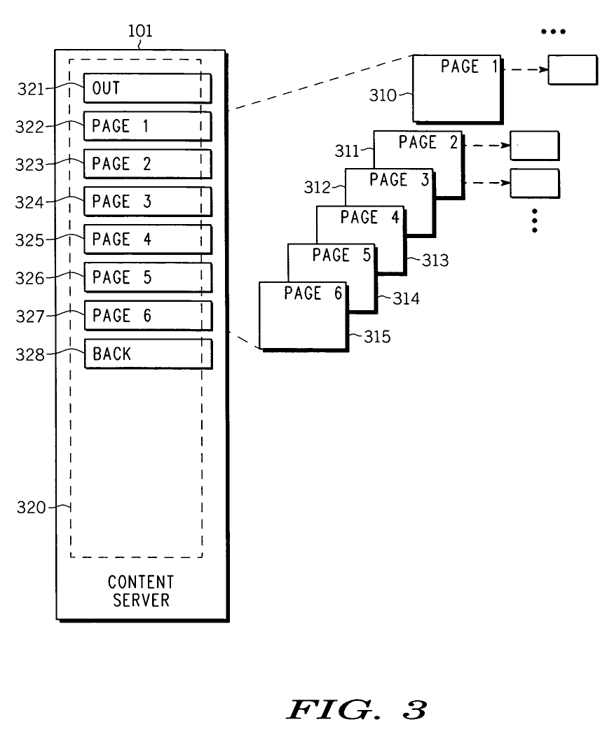

Accordingly, as shown in FIG. 3, the content server 101 or another component or device within the RAN 104 such as the SGSN 106, can be configured to track access to content such as web pages by establishing counts using registers such as software or hardware registers or other storage devices or means as will be described in greater detail hereinafter. It will be appreciated that information content such as high-level or first level web pages 310-315, or the like, stored in connection with the content server 101 as described above for example with reference to FIG. 2, can be accessed by the wireless network clients 210 and 220 through infrastructure components. In addition to first level web pages 310-315 shown and numbered in FIG. 3, each first level page may have links to additional second level web pages each of which may also have links to additional sub level pages as will be appreciated by one of ordinary skill. The content server 101 or other infrastructure components may be configured with a controller or the like such as a processor 320 to create software buffers or registers 321-328 or the registers may be configured in hardware or may be configured in secondary memory such as a storage device, disk drive or the like. The registers 322-327 correspond to the web page 1 310—the web page 6 315 and additional registers 321 and 328 can be used to track OUT and BACK traversals by network clients for the purpose of maintaining request frequency metrics.

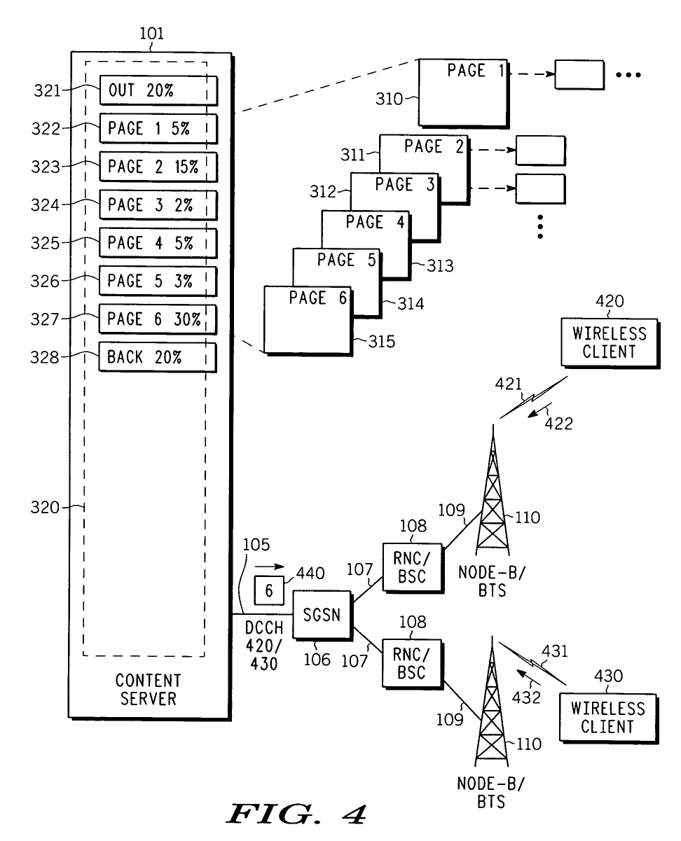

As noted, the content server 101 or other infrastructure component may maintain a count or otherwise track the requests made for web pages to establish various metrics such as a request frequency, a request history, a request profile, or the like, based on tracking all requests from all network clients or based on tracking requests from selected groups of network clients or individual clients. In addition, metrics gathered from one group of clients or an individual client may be used in making transfer decisions affecting other clients or groups of clients. For example, as shown in FIG. 4, wireless network clients 420 and 430 can make requests 422 and 432 for content from the Internet 102 in the form of the web pages 310-315 available on the content server 101 using the wireless network interfaces 421, and 431.

According to the content to which the requests 422 and 432 are directed, a count can be added to the registers 321-328 such that the request frequency, request history, request profile, or the like, can be updated. It will be appreciated that the request frequency, request history, request profile, or the like, can be in the form of a tracking of a percentage of all network requests or, a percentage of network requests from a specific user or may be in other forms as will be appreciated by one of ordinary skill in the art. As noted, request histories such as percentages associated with one group or individual client can be used to affect transfer decisions for other groups or individuals. For example, if the wireless network clients 420 and 430 belong to a group of users who often make the same requests, or are identified as members of a user group such as a dispatch call group or as a multicast group, that is a group with a Class D IP address in accordance with, for example, Internet Group Management Protocol (IGMP) version 2, Internet Engineering Task Force (IETF) Request for Comments (RFC) 2236 November 1997, and IGMP version 3 in draft on March 2001, and the like, then requests associated with the wireless clients 420 and 430 can be further associated with metrics for the group and vice versa. In tracking requests made by a group at large, the present invention can be used to associate content frequently requested by other members of the group to the wireless network clients 420 and 430 and thereby push the content to the wireless network clients 420 and 430 prior to being requested based on the metrics for the group.

Thus, in accordance with various exemplary embodiments, if the request history shows, for example, that a particular page is requested more often by all or a specific group of clients from the content server 101, including by an individual client, the content associated with the high request frequency page can be “pushed”, that is transferred automatically without waiting for a request, to a network client who is deemed likely to want the content based on selected request frequency, request history, or other metrics. The metrics may be based on, for example, previous requests from the client, previous requests from another client or clients, or previous requests from a selected combination of sources. In the exemplary configuration shown in FIG. 4 for example, the request frequency of 30% stored in a register 327, shows that a page 6 315 is requested more frequently than the other pages and more frequently than back outs or back ups. The content server 101 can thus push the content of the page 6 315 in an automatic transfer 440 to one or both of the wireless network clients 420 or 430 over, for example, a traffic channel such as a respective Dedicated Traffic Channel (DTCH) or the like associated with the wireless network clients 420 and 430. The automatic transfer 440 of the pushed content is advantageous in that it can be transferred during intervals when the content has not been specifically requested, thus any delays in transferring the information will not result in an extended wait for the content by a client who may or is likely to ultimately request and view the content. The same can be true for any pages such as the page 1 310—the page 5 314, that is, if the request frequency shows that any of these pages are requested more frequently, then the content associated with the page can be automatically transferred or “pushed” to one or both of the wireless network clients 420 or 430. In accordance with various exemplary and alternative exemplary embodiments, the content can be pushed to individual network clients or can be pushed directly to all members of a group using, for example, an IP Multicast address for the group.

It should be noted that pushed information or content, that is content which has not been requested but which has been transferred based on a determined request frequency or the like, may be buffered or cached, for example at the wireless client, until the information is actually requested or until further content browsing obviates the need to keep the content within the cache. For example, content can be disposed or placed within a cache having for example a limited memory size based on a combination of time and relevancy. If the content is stale, that is if the content has be cached for a relatively long period of time and if the linking page or pages are no longer being visited, the content can be marked for overwriting or can be cleaned from the cache.

In accordance with various exemplary and alternative exemplary embodiments, an indicator can be provided that content has been downloaded and can be rapidly available upon selection. For example, a link such as a hypertext link associated with content, being displayed on a page being viewed can appear with a unique color or visual attribute (flashing, blinking, etc.) if the content was available through a previous push operation or automatic or autonomous transfer.

It will be understood that establishing groups or associative groupings or profiles for users having similar needs or preferences as noted above, would yield even greater efficiency for the inventive concepts discussed and described herein. In particular, users having similar characteristics or belonging to specific groups can be identified to infrastructure components to facilitate proper maintenance of the directory of request frequencies. While frequency information can be determined based on observing and tracking the behavior of the user or group of users over time, it is also contemplated that frequency information can be explicitly provided or loaded, and can further be adaptive or changeable over time. For example, a device can be placed into certain modes to better define request preferences. Device modes can include, for example, a “work mode” or a “home mode”. In the “home mode”, for example, the device preferences might be grouped with devices known to have sports content as high likelihood content. The request profile of the device can further be manually set or, alternatively, can be adaptively set in accordance with an internal time clock and calendar. Preferences can still further be communicated over a radio link to the infrastructure component where request frequency tracking is performed.

In accordance with still other exemplary embodiments, a request frequency can be determined based on an ongoing count of requests from members of a group, such as clients that share a group IP address. It will be appreciated that requests associated with at least a portion of the group can be counted and, if common request preferences exist between, for example, an individual wireless network client, determination of a likelihood of a transfer can be based on the request frequency of the portion of the group. For example, if some of the group members appear to request page 5 if page 3 is selected, and an individual client shares other common request preference or frequencies, then page 3 will be pushed if page 5 is requested by the individual client.

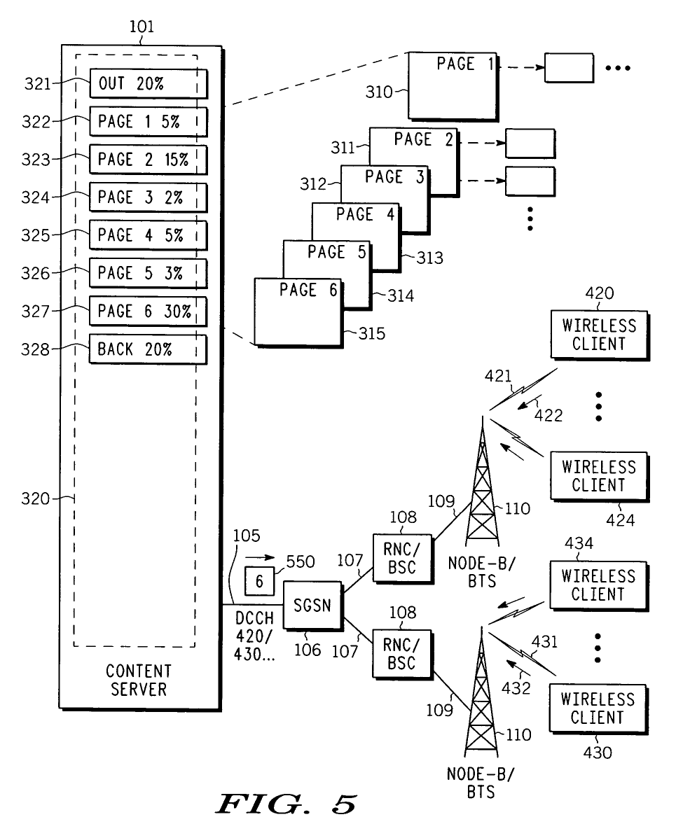

It will be appreciated that while the frequency of out requests and back requests can be tracked, for example in the registers 321 and 328, content for the pages associated with the out and back operations are already cached within the network client and need not be pushed. It will further be appreciated that in accordance with, for example, a broadcast facilitated mode, which is becoming common in wireless systems according to, for example, the 3^{rd} Generation Partnership Project 2, (3GPP2) specification entitled 3GPP2 S.R0030-A Version 1.0, 15 Jan. 2004, Broadcast/Multicast Services or generally referred to as Multimedia Broadcast/Multicast Service (MBMS) and IGMP version 2 and version 3 as noted above, content may be pushed in a broadcast mode. In this mode, a one to many delivery paradigm either over the same wireless system or using an auxiliary broadcast medium can facilitate the push or automatic transfer of high-likelihood content from an exemplary network server to a multitude of wireless network clients. FIG. 5 shows the system of FIG. 4, with the addition of a delivery channel 105 for a pushed content 550 on a Broadcast Channel (BCH) or the like, directed to the wireless network clients 420, 430, and any other clients sharing the group address.

As various wireless network clients and groups of wireless network clients make requests for information from content server 101, the request frequencies of high level pages and sub pages can be updated and depending on which branches of a tree described by the activities of the wireless network client 420 for example, are traversed, different content can be pushed, and the determined likelihood of subsequent or next page requests for the wireless network client 420 can be changed accordingly. Also, as pages are pushed into memory associated with the wireless network client 420 and then determined to be less likely based on activities subsequent to the content push, pages can be discarded from memory or otherwise overwritten. It will be appreciated that if the pages are found to be likely to be loaded based on a future series of page requests, the page content can be pushed again in a similar manner and later cleared again if necessary with the ultimate aim being to have page content locally ready in the cache associated with the wireless network client when the content is actually requested.

As noted, the directory or tracking of page request frequencies occurs during ongoing system operation including normal updating based on ongoing request activities and cache maintenance when content becomes stale or obsolete. For example, as noted, request frequencies may become “stale” over time and may no longer represent the actual likelihood of user selection. To account for staleness, a continuous “leaking” or diminution of likelihood probability can be applied to request frequencies so that over a long period of time the expected request frequency slowly approaches zero. When the request frequency is zero, the content can be marked for overwriting, can be overwritten, or can be discarded. It will be appreciated that numerous other methods may be contemplated and used for frequency list updating without departing from the intended scope of the invention.

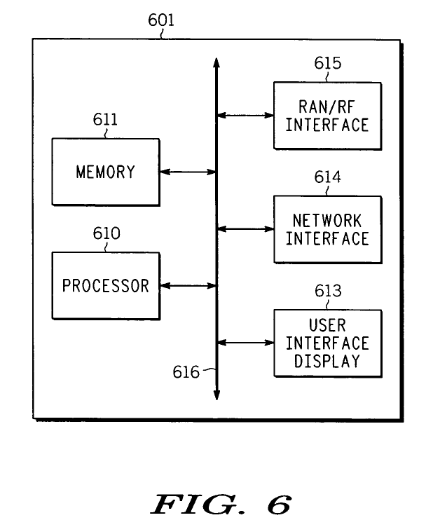

It will be appreciated that the present invention may be implemented as an apparatus such as the exemplary apparatus shown in FIG. 6, which will now be discussed and described. A device 601 which may be an exemplary content server, RAN infrastructure component, or the like as described above, may include a processor 610 and a memory 611 coupled using a bus 616. In accordance with various exemplary and alternative exemplary embodiments, device 601 may also be a communication unit such as a subscriber device, network client or the like. The processor 610 may be a general purpose processor with high speed processing capabilities, particularly in comparison to wireless network clients, although this is not an absolute requirement. The memory 611 can be a memory device such as one or more of a Random Access Memory (RAM), Read Only Memory (ROM), magnetic memory (hard drive), or the like, which matches the transfer speed and access speed requirements associated with the processor 610 and the bus 616. In addition, the device 601 may include a RAN/RF interface 615, particularly where the device 601 is configured as a wireless communication unit or configured to directly serve wireless communication units such as wireless handsets or the like. It will be appreciated that in accordance with some exemplary embodiments, particularly where the RAN/RF interface 615 is used, the device 601 may act simultaneously as a network server or RAN infrastructure component, and as a wireless access point (WAP). The network interface 614 may also provide an interface between the device 601, configured as a content server, and external network clients within the RAN. The device 601 may also include a user interface 613 including, for example, a display, although the user interface 613 is not required to prioritize content for transfer in accordance with exemplary embodiments. In accordance with various exemplary and alternative exemplary embodiments, for example, when the device 601 includes a communication unit or subscriber device, the user interface 613 includes a keyboard or the like for setting an operational mode as will be described hereinafter.

When the device 601 is configured as an exemplary communication unit, such as a network client or a subscriber device, is can be configured to be capable of receiving an automatic information transfer from a Radio Access Network (RAN), using for example the RAN/RF interface 615. The information transfer can be based on a likelihood of a request for a unit of information associated with the information transfer, such as a hypertext link to a content page associated with a World Wide Web site on an Internet network, being generated from the subscriber device. The device 601 includes the processor 610 coupled to the RAN/RF interface 615 and the memory 611. The processor 610 is configured to determine a mode, such as an operational mode associated with the operation of the subscriber device and communicate the mode to the RAN, for example over the RAN/RF interface 615. The mode is used by the RAN to affect the likelihood of the request for the unit of information by identifying a different set of operating conditions or preferences, such as a work mode or a home mode, which in turn can affect desired or likely content, for example as noted above. The mode can be determined from a plurality of different operational modes each having a set of predetermined preferences associated therewith.

It will be appreciated that in addition to the various examples noted herein, mode can refer generally to operational circumstances for a device or user of the device, e.g. an operational state, a operational condition, an operational preference, or the like which can be uniquely identified and used for associative purposes to affect content of information being transferred or automatically being pushed. The likelihood of the request can further be based on a group request frequency for the information such as would be generated, for example, from a group of network clients sharing a group address. Thus it will be appreciated that the exemplary mode can be associated with the group such as car club mode, or the like, such that when the exemplary group mode is selected or otherwise invoked determined or the like, a set of predetermined preferences or request frequencies associated with the group can be loaded, uploaded, or the like.

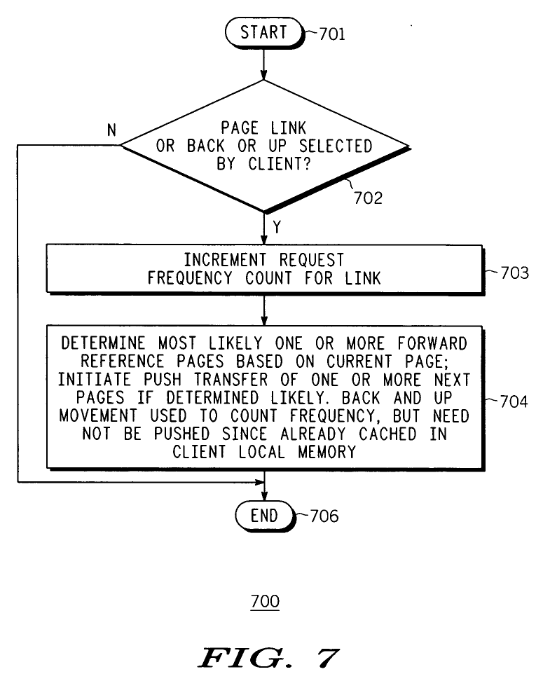

A simplified and representative exemplary procedure for operation in accordance with various exemplary embodiments is shown in FIG. 7. At start 701, such as when the server 101 is powered on and begins network operations, a page request can be initiated through access by a client, such as one of the network clients 420 or 430 at 702. The request is made, as noted above, by sending information associated with the page such as by clicking a hypertext link or the like. In addition, the actions of the network clients 420 and 430 can generate updates to a request frequency metric when a back or out operation is performed as will be appreciated by one of ordinary skill in the art. Thus, when any request is made by any of the network clients 420 and 430, the count associated with the page or other unit of information requested can be incremented and the request frequency updated at 703 in accordance with the page being requested.

For example, if page 6 315 is being requested, the request frequency metric for page 6 315 can be updated in register 327 at 703 to generate an updated request frequency, request history, request profile, or the like. At 704, the most likely one or more forward reference pages or series of forward reference pages can be determined, that is, the one or more pages most likely to be referenced next based on the current page can be determined. It will be appreciated that the forward reference page or pages can include the page or pages most likely to be referenced within one or even several subsequent page references based on the current page. Additional forward page references can include links contained on the next likely forward reference pages which are also likely to be accessed, or non-linked pages which are determined likely to be accessed based on current metrics. Based on the request frequency metrics, or the like, for example, as may already be stored, and additional information such as the current page requests from a client or an associative group, a push transfer operation of the next page or pages can be initiated if a request for the next page is determined to be likely. It should again be noted that while back and up movements can be used to count frequency, the information or pages themselves need not be pushed since they are already most likely cached in, for example, the local memory associated with the network client. While the procedure can end at 705, it will be appreciated that requests will be ongoing and thus the procedure can loop infinitely waiting for additional requests to be detected whereupon the procedure will repeat at 702. It is noted that one of ordinary skill can experimentally determine the specifics of whether something is likely or not likely keeping in mind a tradeoff between undue user waiting times and undue use of network capacity or limits on local memory sizes, i.e. client cache sizes.

This disclosure is intended to explain how to fashion and use various embodiments in accordance with the invention rather than to limit the true, intended, and fair scope and spirit thereof. The foregoing description is not intended to be exhaustive or to limit the invention to the precise form disclosed. Modifications or variations are possible in light of the above teachings. The embodiment(s) was chosen and described to provide the best illustration of the principles of the invention and its practical application, and to enable one of ordinary skill in the art to utilize the invention in various embodiments and with various modifications as are suited to the particular use contemplated. All such modifications and variations are within the scope of the invention as determined by the appended claims, as may be amended during the pendency of this application for patent, and all equivalents thereof, when interpreted in accordance with the breadth to which they are fairly, legally, and equitably entitled.

What is claimed is:

1. A method for controlling an information transfer between a Radio Access Network and a first network client, the method comprising:
determining a likelihood of a request for a unit of information associated with the information transfer being generated from the first network client to form a determined likelihood; and
transferring the unit of information to the first network client based on the determined likelihood,
wherein the determined likelihood is based on a request frequency for the unit of information from a second network client different from the first network client.

2. A method in accordance with claim 1, wherein the second network client is associated with a group address and wherein the transferring the unit of information includes broadcasting the unit of information using the group address.

3. A method in accordance with claim 1, wherein the determined likelihood is based on a group request frequency for the unit of information from a group of network clients sharing a group address.

4. A method in accordance with claim 1, wherein the transferring the unit of information includes automatically transferring the unit of information to the first network client without the request being generated by the first network client.

5. A method in accordance with claim 1, wherein the determining the likelihood of a request includes tracking requests made by the first network client, the second network client and one or more groups of network clients to form a metric.

6. A method in accordance with claim 5, wherein the transferring the unit of information includes transferring the unit of information to the first network client based on the metric.

7. A method in accordance with claim 1, wherein the network includes an Internet network and wherein the unit of information is associated with a hypertext link to a content page associated with a World Wide Web site on the Internet network.

8. A method in accordance with claim 1, further comprising updating the determined likelihood based on tracking requests made by the first network client, the second network client and one or more groups of network clients.

9. An infrastructure device configured to be capable of facilitating the transfer of information between a Radio Access Network (RAN) and a first network client, the infrastructure device comprising:
a RAN interface;
a memory; and
a processor coupled to the RAN interface and the memory, the memory storing instructions for causing the processor to:
track a past request for a unit of information associated with the RAN to form a first request history;
establish a likelihood of a future request for the unit of the information associated with the RAN by the first network client based on the first request history; and
transfer the unit of information to the first network client based on the likelihood.

10. An infrastructure device in accordance with claim 9, further comprising a second network client different from the first network client, wherein the processor is further configured to establish the likelihood of the future request based on a request frequency for the unit of information from the second network client.

11. An infrastructure device in accordance with claim 9, wherein the processor is further configured to establish a request profile associated with the first network client, the request profile including a second request history associated with the first network client, wherein the likelihood of the future request is further based on the request profile.

12. An infrastructure device in accordance with claim 9, wherein the processor, in transferring, is further configured to automatically transfer the unit of information to the first network client without the future request being generated by the first network client.

13. An infrastructure device in accordance with claim 9, wherein the RAN includes an Internet network; and wherein the unit of information includes a page associated with an Internet website.

14. An infrastructure device in accordance with claim 9, wherein the first network client includes a wireless communication unit.

15. A method for transferring information associated with a content server between a Radio Access Network (RAN) and a first network client having a group address, the method comprising:
counting requests for a unit of information associated with the content server from a group of clients sharing the group address to form a group request frequency;
determining a likelihood of a request for the unit of information being generated from the first network client based on the group request frequency to form a determined likelihood; and
transferring the unit of information to the first network client based on the determined likelihood.

16. A method in accordance with claim 15, wherein the transferring the unit of information includes broadcasting the unit of information using the group address.

17. A method in accordance with claim 15, further comprising establishing a request profile associated with the first network client based on a partial request frequency associated with a portion of the group,
wherein the determined likelihood is based on the request profile.

18. A method in accordance with claim 17, wherein the request profile reflects a common request preference associated with the portion of the group and the first network client.

19. A method in accordance with claim 15, wherein the transferring the unit of information includes automatically transferring the unit of information to the first network client without the request being generated by the first network client.

20. A method in accordance with claim 15, wherein the first network client includes a wireless communication unit.

21. A subscriber device configured to be capable of receiving an automatic information transfer from a Radio Access Network (RAN), the information transfer based on a likelihood of a request for a unit of information associated with the information transfer being generated from the subscriber device:
a RAN interface;
a memory; and
a processor coupled to the RAN interface and the memory, the processor configured to:
determine a mode associated with the operation of the subscriber device; and
communicate the mode to the RAN over the RAN interface,
wherein the mode is used by the RAN to affect the likelihood of the request for the unit of information.

22. A subscriber device in accordance with claim 21, wherein the processor, in determining the mode, is further configured to determine the mode from a plurality of modes, each of the plurality of modes having a set of predetermined preferences.

23. A subscriber device in accordance with claim 21, wherein the RAN is connected to an Internet network and wherein the unit of information is associated with a hypertext link to a content page associated with a World Wide Web site on the Internet network.

24. A subscriber device in accordance with claim 21, wherein the likelihood of the request is based on a group request frequency for the unit of information from a group of network clients sharing a group address.

25. A subscriber device in accordance with claim 24, wherein the group of network clients sharing the group address is associated with the mode.
